(19) United States
(12) Patent Application Publication
(10) Pub. No.: US 2005/0039509 A1
(43) Pub. Date: Feb. 24, 2005

(54) Phosphate replacement fertilizers

(76) Inventor: Stephen C. Muma, Modesto, CA (US)

Correspondence Address: David L. Hitchcock;Sidley Austin Brown & Wood LLP., Suite 3400, 717 N. Harwood, Dallas, TX, 75201, US

(21) Appl. No.: 10/672,135

(22) Filed: Sep. 26, 2003

Related U.S. Application Data
(60) Provisional application No. 60/414,376, filed on Sep. 27, 2002.

(51) Int. Cl. C05F 11/02

(52) U.S. Cl. 71/24

(57) ABSTRACT

A dry, solid composition comprising humate combined with a phosphate source is disclosed which significantly increases the phosphate absorption efficiency of phosphate fertilizers. Solid humate/phosphate fertilizer compositions, optionally comprising a binding agent containing a soil microbe food source and/or a phosphate-solubilizing microorganism inoculant, their use, and processes for manufacturing these compositions are disclosed.

### CROSS-REFERENCE TO RELATED APPLICATION

This application claims the benefit of U.S. Provisional Application Ser. No. 60/414,376 filed Sep. 27, 2003.

### TECHNICAL FIELD OF THE INVENTION

The invention relates to a fertilizer product, its method of use, and process for making it.

### BACKGROUND

Phosphorus, nitrogen and potassium are primary nutrients required in abundance for plant growth and often must be furnished by fertilizers. Phosphorus sources commonly found in dry or solid fertilizers in the form of phosphates include a mixture of one or more of the following phosphate salts: monoammonium phosphate (“MAP”), diammonium phosphate (“DAP”), dicalcium orthophosphate, calcium biphosphate, calcium orthophosphate, monopotassium phosphate, and tripotassium orthophosphate.

The efficiency of phosphate absorption from solid phosphate-containing fertilizers generally averages only 7% to 8% by weight. That is, out of 100 kilograms of phosphate applied to a field, only 7 kilograms is actually absorbed by the plants, with the remaining 93 kilograms converted to insoluble waste products. For example, orthophosphates such as monoammonium phosphate (“MAP”) and diammonium phosphate (“DAP”) readily tie up in the soil very soon after application. Therefore, improvements in phosphate absorption efficiencies from fertilizers are needed.

Natural rock phosphate (“NRP”), or phosphorite, is a rock consisting largely of a natural calcium phosphate which is often used as a raw material for the manufacture of phosphate-containing fertilizers. NPR in its raw form is preferred for organic farming. The amount of absorbable phosphate from untreated natural rock phosphate is equivalent to less than 1% by weight, and its agronomic benefit depends upon the fineness of the grind as well as soil conditions.

To increase the amount of phosphate absorption from rock phosphate, superphosphates have been produced by reacting rock phosphate with inorganic acids such as sulfuric acid to create phosphoric acid. Treatment with sulfuric acid has resulted in normal or single superphosphates exhibiting as much as 20% absorbable phosphate. Triple superphosphates resulting from phosphoric acid treatment have demonstrated as much as 45% phosphate absorption efficiency. While the result of acid treatment of rock phosphate is increased availability of absorbable phosphate, the absorbable phosphate remains available for only a short window of time before it converts to an insoluble, and therefore, unabsorbable form. Also, these acid-treated rock phosphate manufacturing techniques, while improving the amount of absorbable phosphate obtainable from rock phosphate, disqualify their use for “organically grown” produce (Federal Organic Foods Production Act of 1990).

Humates are geological deposits of highly oxygenated lignite, commonly referred to as Leonardite, soft coal, brown coal, soft brown coal or oxidized lignite, and often used as natural organic concentrated composts providing high concentrations of humic acid. Humates are known to provide improvements to soil conditions by retaining nutrients and water soluble inorganic fertilizers in usable form and releasing them to growing plants as needed; aerating and reducing soil erosion; and increasing the water holding capacity of soils. Application of humates to soil either independently or along with water soluble inorganic fertilizers has been previously reported to improve soil conditions.

Chinese Patent No. 1192427 discloses the manufacture of a liquid organic fertilizer by fermenting organic waste product and adding chemical and trace-element fertilizers. Humic acid is mentioned as one of many optional components in the disclosed fermented fertilizer.

Chinese Patent No. 1165127 discloses the preparation of a granular fertilizer containing a bacterial fertilizer portion, an organic fertilizer portion, and an inorganic fertilizer portion. The bacterial fertilizer portion contains three bacterial strains from the Agricultural Culture Collection of China: Bacillus megaterium strain 10010, reported to decompose organic phosphorus; Bacillus mucilaginosus strain 10012, reported as a silicate bacteria fertilizer, and strain 40021. The inorganic fertilizer portion contains numerous chemical components including calcium-magnesium phosphate (at about 8% by weight of final product), calcium superphosphate (at about 8% by weight of final product), and humic acid salt (at about 0.05% by weight of final product). The organic fertilizer contains straw, fowl dung, active pool mud, plant ash or coal slag and lime. The bacterial fertilizer, an organic fertilizer, and an inorganic fertilizer portions are first mixed and then pelletized, with phosphate and humic acid salt being minor components of the overall product.

Chinese Patent No. 1150941 discloses the manufacturing process of a coated granular fertilizer comprising one or more chemical fertilizers selected from the group consisting of N fertilizers, P fertilizers, K fertilizers, and humic acid fertilizers, wherein the chemical fertilizers are coated by spraying with liquid coating material, dried, and oxidized in a pelleting tower. The P fertilizers include among others ground rock phosphate, triple superphosphate, double superphosphate, normal superphosphate, ammonium phosphate, and calcium phosphate. The coating material includes animal glue, solubilizer, organic acid, inorganic acid, plant nutrient compound, surfactant, and water.

It has now been found that humate comprising humic acid when combined with a phosphate source in a dry, homogenous composition significantly increases the phosphate absorption efficiency of phosphate fertilizers. Solid humate/phosphate fertilizer compositions, optionally comprising a binding agent containing a soil microbe food source and/or a phosphate-solubilizing microorganism inoculant, their use, and processes for manufacturing these compositions are disclosed herein.

### SUMMARY OF THE INVENTION

In one aspect, the invention is a solid fertilizer composition comprising a granular admixture of humate and a phosphate source which has been pressed together in a granular form, wherein the concentration of the humate is equal to or greater than 5% by weight of the final composition and the concentration of the phosphate source is equal to or greater than 5% by weight of the final composition, and the balance being selected from the group consisting of binders, inoculants, plant nutrient sources, microorganism nutrient sources, iron, phosphate-solubilizing agents, chelating agents, and combinations thereof. In one embodiment, this solid fertilizer composition further comprises a moisture barrier agent coated on the granular admixture.

In another aspect, the invention is a solid fertilizer composition comprising a granular admixture having the composition of from 5% to 90% by weight of a phosphate source; from 5% to 90% by weight of a humate; and the balance selected from the group consisting of binders, inoculants, plant nutrient sources, microorganism nutrient sources, iron, phosphate-solubilizing agents, chelating agents, coating agents and combinations thereof. In another embodiment, this solid fertilizer composition further comprises at least one carbohydrate-containing binding agent. In another embodiment, this solid fertilizer composition further comprises a phosphate-solubilizing microorganism inoculant. In yet another embodiment, this solid fertilizer composition further comprises at least one carbohydrate-containing binding agent and a phosphate-solubilizing microorganism inoculant. The phosphate source in these fertilizer compositions can be natural rock phosphate, preferably added at a concentration wherein the humate and natural rock phosphate are combined in a ratio within the range of from 1:1 to 5:1 by weight. The phosphate source in these fertilizer compositions can be also be monoammonium phosphate, preferably added at a concentration wherein the humate and monoammonium phosphate are combined in a ratio within the range of 3:1 to 2:1 by weight.

In another aspect, the invention is a solid fertilizer composition comprising a granular admixture having the composition of from 10% to 80% by weight of a phosphate source; from 20% to 80% by weight of a humate; and the balance selected from the group consisting of binders, inoculants, plant nutrient sources, microorganism nutrient sources, iron, phosphate-solubilizing agents, chelating agents, coating agents and combinations thereof.

In another aspect, the invention is a solid fertilizer composition comprising a granular admixture having the composition of from 5% to 60% by weight of a phosphate source; from 35% to 65% by weight of a humate; and the balance selected from the group consisting of binders, inoculants, plant nutrient sources, microorganism nutrient sources, iron, phosphate-solubilizing agents, chelating agents, coating agents and combinations thereof.

In another aspect, the invention is a fertilizer composition comprising a granulized admixture of at least 5% by weight of a phosphate source and at least 1.5% by weight of humic acid equivalent.

In another aspect, the invention is a solid fertilizer composition comprising a granular admixture having the composition of from 5% to 90% by weight of a phosphate source; from 1% to 63% by weight of a humate; and the balance selected from the group consisting of binders, inoculants, plant nutrient sources, microorganism nutrient sources, iron, phosphate-solubilizing agents, chelating agents, coating agents and combinations thereof.

In another aspect, the invention is a solid fertilizer composition comprising a granular admixture having the composition of from 10% to 80% by weight of a phosphate source; from 1% to 56% by weight of a humic acid equivalent; and the balance selected from the group consisting of binders, inoculants, plant nutrient sources, microorganism nutrient sources, iron, phosphate-solubilizing agents, chelating agents, coating agents and combinations thereof.

In another aspect, the invention is a solid fertilizer composition comprising a granular admixture having the composition of from 5% to 60% by weight of a phosphate source; from 1.5% to 42% by weight of a humic acid equivalent; and the balance selected from the group consisting of binders, inoculants, plant nutrient sources, microorganism nutrient sources, iron, phosphate-solubilizing agents, chelating agents, coating agents and combinations thereof.

In another aspect, the invention is a solid fertilizer composition comprising 47.95% humate by weight of the final product, 47.95% natural rock phosphate by weight of final product, 4% iron oxide ore by weight of the final product, and about 0.1% carbohydrate-containing binding agent by weight of the final product.

In another aspect, the invention is a solid fertilizer composition comprising 47.9% humate by weight of the final product, 47.9% natural rock phosphate by weight of final product, 4% iron oxide ore by weight of the final product, about 0.1% carbohydrate-containing binding agent by weight of the final product, and 0.1% microorganism inoculant by weight of the final product.

In another aspect, the invention is a solid fertilizer composition comprising 70.95% humate by weight of the final product, 24.95% monoammonium phosphate by weight of final product, 4% iron oxide ore by weight of the final product, and about 0.1% carbohydrate-containing binding agent by weight of the final product.

In another aspect, the invention is a solid fertilizer composition comprising 70.9% humate by weight of the final product, 24.9% monoammonium phosphate by weight of final product, 4% iron oxide ore by weight of the final product, about 0.1% carbohydrate-containing binding agent by weight of the final product, and 0.1% microorganism inoculant by weight of the final product.

In another aspect, the invention is a process for manufacturing a solid fertilizer composition comprising admixing at least a humate and a phosphate source while maintaining the temperature of the admixture below 100 degrees C. and forming the admixture into pressed together granules of a predetermined size while maintaining the temperature of the admixture below 100 degrees C. More preferred, the temperature is maintained below 80 degrees C. during admixing and forming pressed together granules. Even more preferred, the temperature is maintained below 65.6 degrees C. during admixing and forming pressed together granules. This process can also further comprise applying a water repellant coating agent to the granules.

In another aspect, the invention is a solid fertilizer composition manufactured according to the steps of admixing at least a humate and a phosphate source while maintaining the temperature of the admixture below 100 degrees C. and forming the admixture into pressed together granules of a predetermined size while maintaining the temperature of the admixture below 100 degrees C. This process can also further comprise applying a water repellant coating agent to the granules.

In another aspect, the invention is a process for producing a granular fertilizer composition comprising admixing a humate and a phosphate source while maintaining the temperature of the mixture below 100 degrees C. and forming granules from the admixture by pressing the admixture together while maintaining the temperature of the admixture below 100 degrees C. More preferably, the temperature is held below 80 degrees C. during the entire process. Even more preferably, the temperature is held below 65.6 degrees C. during the entire process. This process can also further comprise applying a water repellant coating agent to the granules. A product produced by this process is also contemplated as one aspect of the invention.

In another aspect, the invention is a process for producing a granular fertilizer composition comprising admixing at least 1.5% humic acid by weight of final product and a phosphate source while maintaining the temperature of the mixture below 100 degrees C. and forming granules from the admixture by pressing the admixture together while maintaining the temperature of the admixture below 100 degrees C. More preferably, the temperature is held below 80 degrees C. during the entire process. Even more preferably, the temperature is held below 65.6 degrees C. during the entire process. This process can also further comprise applying a water repellant coating agent to the granules. A product produced by this process is also contemplated as one aspect of the invention.

In another aspect, the invention is a process for producing a granular fertilizer composition comprising admixing at least 1.5% humic acid by weight of final product and a phosphate source while maintaining the temperature of the mixture below 100 degrees C. to form an admixture, pressing the admixture together at a pressure between 175.8 and 246.1 kilogram-force per square centimeter while maintaining the temperature of the admixture below 100 degrees C., and then breaking the resultant product into granules. This process can further comprise screening the resultant granules to a predetermined size range while maintaining the temperature at less than 100 degrees C. This process can also further comprise applying a water repellant coating agent to the granules. A product produced by this process is also contemplated as one aspect of the invention.

In another aspect, the invention is a process for producing a granular fertilizer composition comprising admixing at least 1.5% humic acid by weight of final product and a phosphate source while maintaining the temperature of the mixture below 80 degrees C. to form an admixture, pressing the admixture together at a pressure between 175.8 and 246.1 kilogram-force per square centimeter while maintaining the temperature of the admixture below 80 degrees C., and then breaking the resultant product into granules. This process can further comprise screening the resultant granules to a predetermined size range while maintaining the temperature at less than 100 degrees C. This process can also further comprise applying a water repellant coating agent to the granules. A product produced by this process is also contemplated as one aspect of the invention.

In another aspect, the invention is a process for producing a granular fertilizer composition comprising admixing from 10% to 80% by weight of a phosphate source, from 20% to 80% by weight of a humate, and the balance selected from the group consisting of binders, inoculants, plant nutrient sources, microorganism nutrient sources, iron, phosphate-solubilizing agents, chelating agents, coating agents and combinations thereof to form an admixture while maintaining the temperature below 100 degrees C.; and pressing the admixture together at a pressure between 175.8 and 246.1 kilogram-force per square centimeter while maintaining the temperature of the mixture below 100 degrees C. This process can further comprise breaking the resultant product into granules while maintaining the temperature at less than 100 degrees C. More preferably, the temperature of this process is held below 80 degrees C. Even more preferably, the temperature of this process is held below 65.6 degrees C. A product produced by this process is also contemplated as one aspect of the invention.

### BRIEF DESCRIPTION OF THE DRAWINGS

FIG. 1 depicts the average dry weight in grams per broccoli plant for each treatment group shown from left to right: Treatment Group 1B, 2B, 3B, 5B and 6B. Treatment Group 1B was treated with a fertilizer composition containing natural rock phosphate (NRP), high grade Leonardite ore (Hi Grade), iron ore (Red Ore), carbohydrate-containing binding agent (CSL), and bacterial inoculant (Bugs). Treatment Group 2B was treated with a fertilizer composition containing monoammonium phosphate (MAP), high grade Leonardite ore (Hi Grade), iron ore (Red Ore), carbohydrate-containing binding agent (CSL), and bacterial inoculant (Bugs). Treatment Group 3B was treated with monoammonium phosphate (MAP) alone. Treatment Group 5B was treated with a fertilizer composition containing monoammonium phosphate (MAP) and high grade Leonardite ore (Hi Grade). Treatment Group 6B was the non-fertilized control group.

FIG. 2 depicts the total amount of phosphorus uptake by the broccoli plants for each treatment group (from left to right, Treatment Group 1B, 2B, 3B, 5B, and 6B), as estimated by multiplying the average dry weight of the broccoli plant with the percent phosphorus determined by tissue analysis of the broccoli shoots.

### DETAILED DESCRIPTION OF THE INVENTION

The solid fertilizer compositions of the present invention comprise humates in combination with natural rock phosphate and/or other phosphate fertilizer sources, and optionally, at least one phosphate-solubilizing microorganism source and at least one carbohydrate-containing binding agent.

Upon application to the soil, the combination of humates and a carbohydrate source stimulates the phosphate-solubilizing activity of soil microorganisms, leading to a biological breakdown of the phosphate source to a plant-available phosphate form. Further, the humic acids provided by the solid fertilizer composition forms complexes with the plant-available phosphate, thus stabilizing the phosphate in a soluble plant-available state over the plant growing cycle. The phosphate-solubilizing microbiological activity can be provided by one or more of the following sources: (1) phosphate-solubilizing microorganisms naturally found in the soil, (2) microbiological inoculant(s) added to the soil, or (3) microbiological inoculant(s) optionally supplied in the solid fertilizer compositions of the present invention. The solid phosphate replacement fertilizer compositions of the present invention provide increased phosphate absorption efficiency.

In a humate product, the amount of available humic acid varies dependent upon the source of the humate from as low as 5% humic acid by weight up to 90% humic acid by weight, and thus, these products are standardized by their equivalent amount of humic acid. Preferred humates of the present invention comprise about 30% to 90% humic acid by total weight of the humate. To assess the amount of humic acid in a humate product, the most widely accepted method by the humate industry in North America is the test performed by A&L Western Laboratories in Modesto, Calif. It is an adaptation of a method published by A. Mehlich in 1984 (Mehlich A. 1984. “Photometric determination of humic matter in soils, a proposed method,” Commun in Soil Sci Plant Anal 15 (12):1417-1422). This procedure uses a spectrophotometer to measure absorbance of light at a wavelength of 650 nanometers passing through humic acids in liquid phase. The humic acid concentration is determined by comparing it to a standard curve using a known humic acid concentration sample made from humic acid salt obtained from a commercial source such as Aldrich Chemicals (Milwaukee, Wis.). The method can be used for either dry or liquid humic acids. Dry humic acids are dissolved using a standard solution of 0.1 N sodium hydroxide.

In the compositions of the present invention, the amount of humates or Leonardite ore ranges from about 5% to about 90% (ranging from about 1.5% to about 81% humic acid equivalent) by weight of the final composition; more preferably, from about 20% to about 80% (ranging from about 6% to about 72% humic acid equivalent) by weight of the final composition; and most preferably, from about 35% to about 65% (ranging from about 10.5% to about 58.5% humic acid equivalent) by weight of the final composition.

Any solid agronomically suitable phosphate is useful in the present invention, e.g., natural rock phosphate, MAP, DAP, single superphosphates or triple superphosphates, used either singly or in combination. Compositions of the present invention preferably comprise natural rock phosphate in an amount ranging from about 5% to about 90% by weight of the final composition; more preferably, from about 10% to about 80% by weight of the final composition; most preferably, from about 30% to about 60% by weight of the final composition. Other preferred compositions of the present invention comprise MAP in an amount ranging from about 5% to about 90% by weight of the final composition; more preferably, from about 10% to about 60% by weight of the final composition; most preferably, from about 15% to about 40% by weight of the final composition.

In one aspect, the solid fertilizer compositions of the present invention are an admixture comprising an (a) a humate in the range of from 5% to 90% (equivalent to 1.5% to 81% humic acid) by weight of the final product; a phosphate source in the range of from 5% to 90% by weight of the final product; and the balance selected from the group consisting of binders, inoculants, plant nutrient sources, microorganism nutrient sources, iron, phosphate-solubilizing agents, chelating agents, coating agents and combinations thereof, wherein the admixture is maintained at or below 100 degrees C. during manufacture.

In one aspect, the solid fertilizer compositions of the present invention are custom-made formulations. For custom-made formulations, the pretreated soil is first analyzed for key components including but not limited to the amount of natural phosphate, organic matter, pH, nitrogen, potassium, alkaline earth metals, trace minerals, iron, and microbial content. Based upon the analysis of the soil, a custom blend is prepared comprising humates, a phosphate fertilizer source, and optionally, phosphate-solubilizing microorganisms, carbohydrate-containing binding agents, and/or other nutrient additives. For example, a exemplary custom-made formulation for treating soil rich in organic matter and natural phosphate may contain by weight of the final composition 10% humate (about 3% to 9% about humic acid equivalent), 10% natural rock phosphate, 0.1% microorganism inoculant, and 79.9% other nutrient additives. For soil rich in organic matter but low in phosphates, an exemplary formulation may contain by weight of the final composition 20% humate (about 6% to about 18% humic acid equivalent), 70% natural rock phosphate, 0.1% microorganism inoculant, and 9.9% other nutrient additives. For soil rich in natural phosphates but low in organic matter, an exemplary formulation may contain by weight of final composition 65% humate (about 19.5% to about 58.5% humic acid equivalent), 20% natural rock phosphate, 0.1% microorganism inoculant, 0.1% carbohydrate-containing binding agent, and 14.8% other nutrient additives.

For mass production and most common fertilizer applications, the solid fertilizer compositions of the present invention comprise a phosphate source and Leonardite combined in a range of 1:1 to 1:3 ratio by weight percent of the final product. For formulations comprising a natural rock phosphate and Leonardite, the preferred ratio is 1:1 by weight of the final product (e.g., 45 kilograms natural rock phosphate and 45 kilograms Leonardite (equivalent to about 13.5 kilograms to about 40.5 kilograms humic acid) in one hundred kilograms of final product). For formulations comprising MAP and Leonardite, the preferred ratio is 1:2 to 1:3 by weight percent of the final product (e.g., 30 kilograms MAP and 60 kilograms Leonardite (equivalent to about 18 kilograms to about 54 kilograms humic acid) in one hundred kilograms of final product).

Optionally, the compositions of the present invention comprise at least one microorganism strain capable of enhancing phosphate uptake by plants. The microorganisms useful in the compositions of the present invention include both natural and genetically engineered bacteria and fungi with phosphate-solubilizing traits. Examples of microorganisms known in the art that are useful for this purpose include but are not limited to Arthrobacter globiformis, Arthrobacter simplex, Pseudomonasfluorescens, Streptomyces griseoflavus, Bacillus subtilis, Bacillus polymyxa, Bacillus pumilus, Bacillus macerans, Azosprillum lipoferum, Azotobacter paspali, and Azotobacter chroococcum. Strains of these microorganisms are available from the American Type Culture Collection (ATCC; P.O. Box 1549, Manassas, Va. 20108, USA). Preferably, the microorganism(s) are dormant during storage of the solid fertilizer composition of the present invention and then become activated upon application of the fertilizer composition to moist soil. As used herein, the term “microorganism inoculant” refers to an inoculum comprising one or more phosphate-solubilizing microorganisms.

Optionally, the solid fertilizer compositions of the present invention comprise any binding agent capable of stabilizing the final product during storage, handling, packaging, shipping and application. Preferred binding agents in the compositions of the present invention are carbohydrate-containing food by-product and direct food sources including but not limited to molasses, corn starch, wheat gluten, or combinations thereof. In this case, the binding agent provides appropriate binding properties while it also acts as a carbohydrate source and possibly a protein source for phosphate-solubilizing microorganisms which may be native to the soil, injected into the soil or provided as a component of the phosphate replacement fertilizer of the present invention.

In conjunction with an agronomically suitable phosphate source, the solid fertilizer compositions of the present invention optionally comprise other plant nutrient sources including but not limited to nitrogen, potassium, calcium, sulfur, iron, magnesium, zinc, manganese, copper, boron, molybdenum and cobalt sources. Amino acids, organic acids such as fumarates, tartarates, and acetates, sea kelp, and fish emulsion products may also be added to the composition either in the binding agent or as a dry ingredient. Iron (Fe) in the form of oxides, sulfates, or chlorides may be added to support and enhance the microorganisms. Moreover, substances known in the art to be useful in optimizing the phosphate-solubilizing activity of soil microorganisms can also be added to these fertilizer compositions. For example, synthetic chelating agents such as EDTA may be added.

Optionally, the solid fertilizer compositions of the present invention comprise a coating agent which, upon application to the final product, provides a moisture barrier to decrease susceptibility of the final product to deleterious effects of atmospheric conditions. The coating agent provides for decreased absorption of atmospheric moisture by the final product, enhances shelf-life, increases ease of handling in warehousing, shipping and packaging, and increases ease of use in mixing and application equipment. Coating agents useful in the present invention include but are not limited to oils, polymers, clays, and elemental sulfur.

The amount of each component in the solid fertilizer compositions of the present invention is dependent upon its intended use. One exemplary formulation comprises about 47.95% of Leonardite (equivalent to about 14.4% to 43.2% humic acid; preferably, about 33.6% humic acid) by weight of the final product, about 47.95% natural rock phosphate by weight of the final product, about 4% iron oxide ore by weight of the final product, and about 0.1% carbohydrate-containing binding agent (e.g., molasses) by weight of the final product. This formulation would preferably be used when a microorganism inoculant is separately applied to soil or in soil already containing a significant microorganism bioburden.

Another exemplary formulation comprises about 47.9% Leonardite (equivalent to about 14.4% to 43.1% humic acid; preferably, about 33.6% humic acid) by weight of the final product, about 47.9% natural rock phosphate by weight of the final product, about 4% iron oxide ore by weight of the final product, about 0.1% microorganism inoculant by weight of the final product, and about 0.1% carbohydrate-containing binding agent (e.g., molasses) by weight of the final product. This formulation would preferably be used when the soil lacks a sufficient microorganism bioburden and a separate application of a microorganism inoculant is not desirable.

Another exemplary formulation comprises about 70.95% Leonardite (equivalent to about 21.3% to 63.8% humic acid; preferably 49.7% humic acid) by weight of the final product, about 24.95% monoammonium phosphate (MAP) by weight of the final product, about 4% iron oxide ore by weight of the final product, and about 0.1% carbohydrate-containing binding agent (e.g., molasses) by weight of the final product.

Another exemplary formulation comprises about 70.9% Leonardite (equivalent to about 21.3% to 63.8% humic acid; preferably 49.6% humic acid) by weight of the final product, about 24.9% monoammonium phosphate (MAP) by weight of the final product, about 4% iron oxide ore by weight of the final product, about 0.1% microorganism inoculant by weight of the final product, and about 0.1% carbohydrate-containing binding agent (e.g., molasses) by weight of the final product. This formulation would preferably be used when the soil lacks a sufficient microorganism bioburden and a separate application of a microorganism inoculant is not desirable.

The solid fertilizer compositions of the present invention are preferably granular products that are sized from about 0.2 millimeters to about 12.7 millimeters in diameter; more preferably, from about 0.5 millimeters to about 10.2 millimeters in diameter; most preferably, from about 0.7 millimeters to about 6.4 millimeters in diameter. As measured according to the guidelines in the National Fertilizer Development Center Bulletin Y-147 entitled “Physical Properties of Fertilizers and Methods for Measuring Them,” the crush strength of the final product is preferably at no less than about 0.35 kilogram-force per square centimeter (5 pounds per square inch) of pressure applied to an individual granule before it fractures and an acceptable attrition rate for the final product is no more than about 26% (i.e., no more than 26% of the product breaks down into fines, or powders, during packaging, shipping, and handling).

In another aspect, the present invention relates to the method of using the solid phosphate replacement fertilizer compositions disclosed herein. The intended use of these fertilizer compositions is for soil applications either laid on top of the ground or incorporated into the soil with tillage implements. The product may be mixed with other dry fertilizer ingredients prior to application or used alone. The product may be “broadcast” described as scattered onto the soil, laid down in a “band” on the top of the soil, or injected in a band beneath the soil surface. Typical application equipment can include farm tractors with hoppers and spreading or injection apparatus attached or pulled behind trailer style, specialized dry fertilizer application vehicles that uniformly spread fertilizer over farm ground, airborne crop dusters outfitted with granular spreading devices, and manual labor hand spreading to targets such as the base of trees or vines.

Product application rates are from about 0.1 kilograms per square kilometer (1 pound per acre) to about 111.1 kilograms per square kilometer (1000 pounds per acre) and more preferred from about 0.5 kilograms per square kilometer (5 pounds per acre) to about 44.8 kilograms per square kilometer (400 pounds per acre). Due to the increased absorbable phosphate efficiency of this product, growers will apply one fourth to one half of the total phosphate that they would normally use.

At the time of application of the fertilizer compositions of the present invention, soil can be in virtually any state of preparation including the presence of an actively growing crop. Ideal conditions would include roughing of the soil surface to encourage soil-to-product contact over the greatest surface area. Ideal post application conditions include some degree of soil moisture. Incorporating the product beneath the surface of the soil enhances the opportunity of the product contacting moisture immediately.

Another aspect of the present invention relates to the process by which these solid fertilizer compositions are manufactured and fertilizer compositions made according to this process. The solid fertilizer compositions of the present invention can be made by any method known in the art for combining and cohering solid materials to form a final product for dry, solid application. For example, pellitizers, agglomerators and roller compactors, and roller compaction granulation (“briquetting”) are useful in the manufacture of the fertilizer compositions of the present invention. The briquetting (granulating) method is most preferred due to a lack of required additional moisture in the process. The processing of the formulations of the present invention into a pellet or granular form is especially beneficial because it associates the components in close proximity to one another, thus increasing the interaction between the components.

In a preferred embodiment of the briquetting (granulating) method of the invention, the solid components are ground or milled to a predetermined particle size, if not already in particulate form. The particle size is preferably from 0.25 millimeters in diameter (60 mesh) to 0.074 millimeters in diameter (200 mesh). If the humate is ground, it is ground while maintaining the internal temperature of the humate below about 85 degrees C. and preferably below 67 degrees C. The solid components and any liquid components such as a binding agent are admixed together. The ingredients can be fed into a roller compactor in the concentrations appropriate for a particular formulation and of particulate size that best leads to efficacy in the field and fits within the equipment manufacturers' specifications and guidelines. For some compositions, the roll compactor can be sufficient to produce granules containing the humate and phosphate source and any of the other components present. Preferably, the mixture is first blended using a mechanical mixing device such as a paddle or ribbon blender, then fed into a force feeding screw auger that feeds the mixture into the briquetter where it is drawn between a double roll press where high pressure compacts the mixture into a homogeneous dimpled sheet. During this step, the internal temperature of the mixture is held below about 100 degrees C. and preferably below 67 degrees C. A pressure in the range of 175.8 to 246.1 kilogram-force per square centimeter (2500 to 3500 pounds per square inch) is useful and preferably about 211 kilogram-force per square centimeter (3000 pounds per square inch). This sheet then drops into a coarse flake breaker or a hammer mill causing granulation of the sheet, followed by screening to remove oversize and fines to separate them from the desired granule size. The product is then “polished” and “dried” in a smooth wall drum to remove any loosely attached edges, and then rescreened to remove the “fines” created by polishing. The granules can be of any desired size, however, preferably they range from 0.2 millimeters to 12.7 millimeters in diameter after screening. During each step, the internal temperature of the mixture is kept below 100 degrees C. and preferably below 67 degrees C. After sizing of the product, the product can be coated with a moisture barrier agent, applied by any suitable technique such as spray coating.

An important aspect of the manufacturing process of the present invention is the maintenance of low temperature during manufacture. The temperature can be controlled by controlling the energy input during the various steps, or by providing cooling or a combination thereof. The temperature can be monitored by any known technique such as a thermocouple. Achieving a successful dry composite product is much easier when heat is applied; because the quality parameters of crush strength and attrition can be achieved through several methods and technologies when high temperature above 100 degrees C. is allowed. This practice of high temperature manufacturing of fertilizer compositions comprising humate and a phosphate source, however, negatively impacts the humic acid contained in the humate component of the fertilizer compositions of the present invention and, therefore, significantly reduces the benefits of the humate. To maintain optimal effectiveness of the Leonardite in the solid fertilizer compositions of the present invention, it is preferred that the temperature during the manufacturing process is maintained at less than or equal to 100 degrees C. and preferably less than or equal to 80 degrees C. Most preferably, the temperature is maintained at less than or equal about 65.6 degrees C. Thus, the process of the present invention whereby the temperature of the humate-containing material is maintained at less than or equal to 65.6 degrees C. provides for optimization of the humate efficacy, a significant advancement of the art.

### EXAMPLE 1

### Exemplary Process for Making Fertilizer Composition

Initially, 430.3 kilograms (950 pounds) of pulverized Leonardite (equivalent to about 301.2 kilograms humic acid) is blended with 430.3 kilograms (950 pounds) of finely ground rock phosphate, 36.3 kilograms (80 pounds) of pulverized iron ore, 8.6 kilograms (19 pounds) of molasses, and 0.45 kilograms (1 pound) of microorganism inoculant in a ribbon or paddle blender. The mixture still feels dry to the touch with this amount of moisture from the binding agent. After thorough blending, the mixture is fed into the hopper of a force feed screw type feed system. This forces the mixture between the two rollers of the compaction briquetter at up to 211 kilogram-force per square centimeter (3000 pounds per square inch) of pressure creating a sheet of combined product. This sheet drops through a “granulator” that basically looks like the tines of a rototiller, and the granulator breaks the sheet into particles. The design and speed of these tines partly determines the range of sizes of particles. The product is then run across a screen with 6.3 millimeter (¼^{th} inch) openings, and material that passes through this screen falls onto a screen with 1.6 millimeter (1/16^{th} inch) openings. Anything that is too big to pass through the first screen and small enough to pass through the second screen is recycled back into the paddle or ribbon blender for another pass through the briquetter. Beyond the first screening, the product is polished and dried in a drum drier at low temperature (less than or equal to 65.6 degrees C.). The rolling action of the drum drier knocks any loose edges off of the particles, and a second screening takes place to remove any fines that have dislodged. Lastly, the product is coated with a fine mist of coating agent and allowed to dry for a short period prior to packaging.

### EXAMPLE 2

### Application of Fertilizer Composition to Stone Fruit Trees

In 1999, a trial was conducted in Reedley Calif. on stone fruit trees to test the effectiveness of a fertilizer composition of the present invention for phosphate response.

The test formulation was: 47.9% Leonardite by weight of final product (equivalent to 33.5% humic acid) by weight of final product; 47.9% natural rock phosphate by weight of final product; 4.0% iron oxide ore by weight of final product; 0.1% zinc, copper and boron micronutrient blend by weight of final product; and 0.1% xanthium gum by weight of final product. The ingredients were mixed in a slurry, and band applied to the shoulder of the berm alongside the tree base. Tissue tests were evaluated for uptake of phosphate compared to historical data, and an increase in phosphate levels in the fruit tree tissue tests was noted. Soil samples were analyzed, and an increase in available phosphate in the soil in the treated area was noted compared to historical levels and soil samples taken from the same field in areas that were not treated.

### EXAMPLE 3

### Application of Fertilizer Composition to Broccoli

A trial was conducted at the Fisher Greenhouse in Ripon, Calif. to test the effectiveness of a fertilizer composition of the present invention for phosphate response in broccoli plants grown in pots filled with a non-saline, calcareous soil with a moderate phosphate level.

Several treatments and controls were included in the trial, and each treatment group contained seven broccoli plants:
Treatment Group 1B (mix amount in grams per pot): 0.9 grams natural rock phosphate, 0.9 grams high grade Leonardite ore, 0.18 grams red ore (iron ore), 9 milliliters carbohydrate-containing binding agent, and 0.4 grams bacterial inoculant;
Treatment Group 2B (mix amount in grams per pot): 0.9 grams monoammonium phosphate (MAP), 0.9 grams high grade Leonardite ore, 0.18 grams red ore (iron ore), 9 milliliters carbohydrate-containing binding agent, and 0.4 grams bacterial inoculant;
Treatment Group 3B (mix amount in grams per pot): 0.9 grams MAP alone (equivalent to 224 kilograms/hectare (200 pounds/acre) of applied MAP 11-52-0 dry granular fertilizer;
Treatment Group 5B (mix amount in grams per pot): 0.9 grams MAP and 0.9 grams high grade Leonardite ore (equivalent to 45 kilograms/hectares; 40 pounds/acre); and
Treatment Group 6B: non-fertilized control.
   The fertilizer was applied to the center of the pots in a band about 76 millimeters (3 inches) wide by about 51 millimeters (2 inches) deep. This banding of the fertilizer incorporated so much fertilizer into the soil directly under the seed that a salt effect caused a delay in emergence and a retardation of growth for the MAP control (Treatment Group 3B) versus the non-fertilized control (Treatment Group 6B). The other treatments all had the same amount of phosphate (22.4 kilograms/square kilometer, or 200 pounds/acre, of P₂O₅), but in different forms and with various amounts of other additives as outlined above.

The broccoli was planted and watered using tap water from the nursery every three days, or as needed. Once the plants emerged, the pots were thinned to have only one plant per pot. Over a period of three months, the plants were monitored for emergence, plant height, vigor, and chlorophyll density. After three months, the plants were carefully harvested and weighed on a wet basis and dried for weighing on a dry basis. The dry plants were grouped together for each treatment and analyzed for nutrient contents. The soils from the seven pots for each treatment group were carefully sampled and grouped together and analyzed at a certified soil laboratory for various constituents.

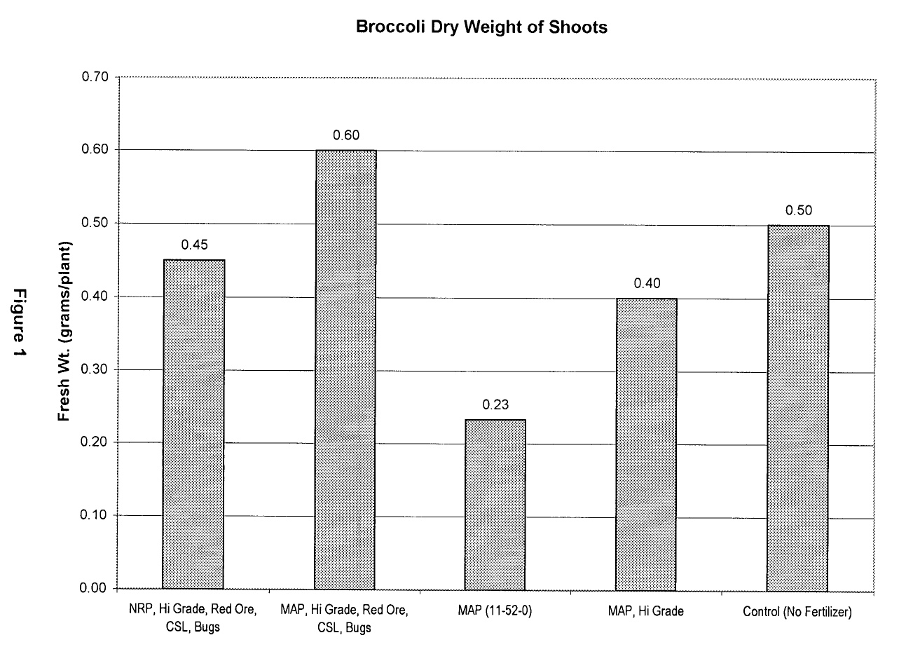

FIG. 1 shows the average dry weight per plant for each treatment group. Plants in Treatment Group 6B (non-fertilized control) averaged 0.45 grams/plant. The best treatment for overall growth and vigor was Treatment Group 2B (MAP, high grade Leonardite ore, red ore, carbohydrate-containing binding agent and bacterial inoculant) at an average of 0.6 grams/plant. All MAP treatments (Treatment Groups 2B, 3B, and 5B) had somewhat retarded growth due to the high salt index in the fertilizer band; however, the addition of high grade Leonardite ore, red ore, carbohydrate-containing binding agent and bacterial inoculant to MAP mitigated this salt effect very well (Treatment Group 2B). The addition of high grade Leonardite ore to MAP (Treatment Group 5B) somewhat reduced the salt effect (0.4 grams/plant) compared to the MAP alone (Treatment Group 3B) at 0.23 grams/plant. The natural rock phosphate treatment (Treatment Group 1B) caused less salt effect as the MAP, so it grew better from the beginning as well, resulting in dry weight of 0.45 grams/plant.

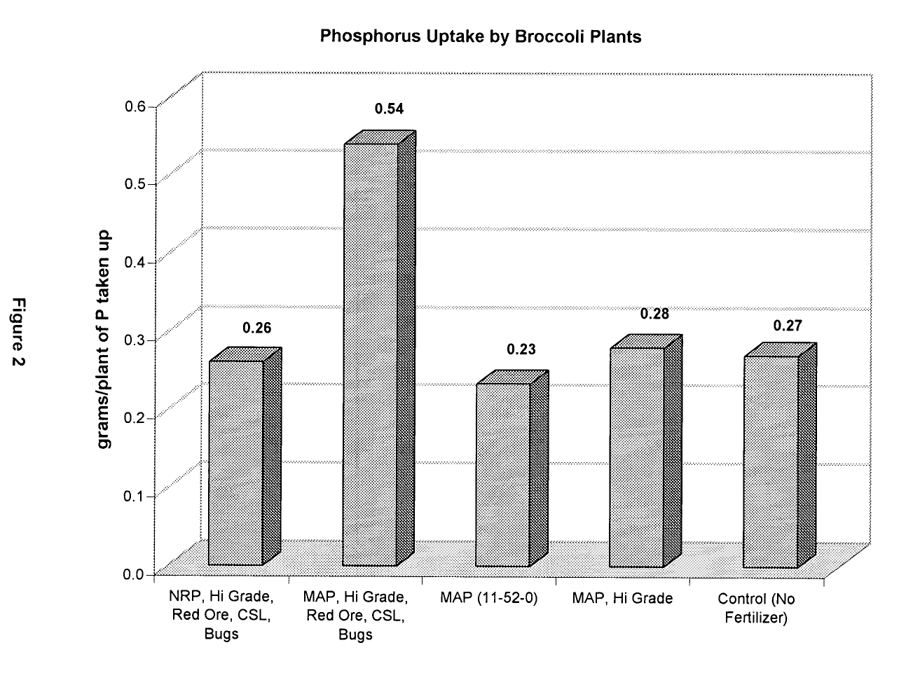

FIG. 2 gives the total amount of phosphorus uptake by the broccoli plants for each treatment group, as estimated by multiplying the average dry weight of the plant with the percent phosphorus in the tissue analysis of the broccoli shoots. Treatment Group 2B (MAP, high grade Leonardite ore, red ore, carbohydrate-containing binding agent and bacterial inoculant) had the best phosphorus uptake at 0.54 grams/plant. Phosphorus uptake for the other treatment groups was 0.26, 0.23, 0.28, and 0.27 grams/plant for Treatment Group 1B, 3B, 5B and 6B, respectively. Due to the salinity of the fertilized band, plants in Treatment Group 3B (MAP alone) actually took up less phosphorus than the non-fertilized control (Treatment Group 6B). The presence of the high grade Leonardite ore (humate) helped slightly as shown in Treatment Group 5B. However, the addition of high grade Leonardite ore, red ore, carbohydrate-containing binding agent and bacterial inoculant to MAP (Treatment Group 2B) more than doubled the amount of phosphorus taken up relative to the MAP alone (Treatment Group 3B).

In summary, the study indicated that high grade Leonardite ore (humate) was somewhat effective at reducing the salt effects of banded MAP fertilizer. But the combination of high grade Leonardite ore, red ore, carbohydrate-containing binding agent and bacterial inoculant mitigated this salt effects of banded MAP fertilizer. The addition of high grade Leonardite ore, red ore, carbohydrate-containing binding agent and bacterial inoculant promoted the best growth and best phosphorus uptake when combined with MAP. Although the combination of high grade Leonardite ore, red ore, carbohydrate-containing binding agent and bacterial inoculant may add value to natural rock phosphate, the best treatment was when this addition was combined with MAP. The combination of high grade Leonardite ore, red ore, carbohydrate-containing binding agent and bacterial inoculant has the potential to dramatically improve the availability and uptake of phosphorus from dry ammonium phosphate fertilizer and also helps protect the plants from the effects of salt burn.

1. A solid fertilizer composition comprising: a granular admixture of humate and a phosphate source which has been pressed together in a granular form, wherein the concentration of said humate is equal to or greater than 5% by weight of the final composition and the concentration of said phosphate source is equal to or greater than 5% by weight of the final composition, the balance being selected from the group consisting of binders, inoculants, plant nutrient sources, microorganism nutrient sources, iron, phosphate-solubilizing agents, chelating agents, and combinations thereof.

2. A solid fertilizer composition of claim 1, further comprising a moisture barrier agent coated on said granular admixture.

3. A solid fertilizer composition comprising a granular admixture having the composition of:
a. from 5% to 90% by weight of a phosphate source;
b. from 5% to 90% by weight of a humate; and
c. the balance selected from the group consisting of binders, inoculants, plant nutrient sources, microorganism nutrient sources, iron, phosphate-solubilizing agents, chelating agents, coating agents and combinations thereof.

4. The fertilizer composition of claim 3, further comprising at least one carbohydrate-containing binding agent.

5. The fertilizer composition of claim 3, further comprising a phosphate-solubilizing microorganism inoculant.

6. The fertilizer composition of claim 4, further comprising a phosphate-solubilizing microorganism inoculant.

7. The fertilizer composition of claim 1, 2, 3, 4, 5 or 6, wherein said phosphate source is natural rock phosphate.

8. The fertilizer composition of claim 7, wherein said humate and natural rock phosphate are combined in a ratio within the range of from 1:1 to 5:1 by weight.

9. The fertilizer composition of claim 1, 2, 3, 4, 5 or 6, wherein said phosphate source is monoammonium phosphate.

10. The fertilizer composition of claim 9, wherein said humate and monoammonium phosphate are combined in a ratio within the range of 3:1 to 2:1 by weight.

11. A solid fertilizer composition comprising a granular admixture having the composition of:
a. from 10% to 80% by weight of a phosphate source;
b. from 20% to 80% by weight of a humate; and
c. the balance selected from the group consisting of binders, inoculants, plant nutrient sources, microorganism nutrient sources, iron, phosphate-solubilizing agents, chelating agents, coating agents and combinations thereof.

12. A solid fertilizer composition comprising a granular admixture having the composition of:
a. from 5% to 60% by weight of a phosphate source;
b. from 35% to 65% by weight of a humate; and
c. the balance selected from the group consisting of binders, inoculants, plant nutrient sources, microorganism nutrient sources, iron, phosphate-solubilizing agents, chelating agents, coating agents and combinations thereof.

13. A fertilizer composition comprising a granulized admixture of at least 5% by weight of a phosphate source and at least 1.5% by weight of humic acid equivalent.

14. A solid fertilizer composition comprising a granular admixture having the composition of:
a. from 5% to 90% by weight of a phosphate source;
b. from 1% to 63% by weight of a humate; and
c. the balance selected from the group consisting of binders, inoculants, plant nutrient sources, microorganism nutrient sources, iron, phosphate-solubilizing agents, chelating agents, coating agents and combinations thereof.

15. A solid fertilizer composition comprising a granular admixture having the composition of:
a. from 10% to 80% by weight of a phosphate source;
b. from 1% to 56% by weight of a humic acid equivalent; and
c. the balance selected from the group consisting of binders, inoculants, plant nutrient sources, microorganism nutrient sources, iron, phosphate-solubilizing agents, chelating agents, coating agents and combinations thereof.

16. A solid fertilizer composition comprising a granular admixture having the composition of:
a. from 5% to 60% by weight of a phosphate source;
b. from 1.5% to 42% by weight of a humic acid equivalent; and
c. the balance selected from the group consisting of binders, inoculants, plant nutrient sources, microorganism nutrient sources, iron, phosphate-solubilizing agents, chelating agents, coating agents and combinations thereof.

17. A solid fertilizer composition comprising 47.95% humate by weight of the final product, 47.95% natural rock phosphate by weight of final product, 4% iron oxide ore by weight of the final product, and about 0.1% carbohydrate-containing binding agent by weight of the final product.

18. A solid fertilizer composition comprising 47.9% humate by weight of the final product, 47.9% natural rock phosphate by weight of final product, 4% iron oxide ore by weight of the final product, about 0.1% carbohydrate-containing binding agent by weight of the final product, and 0.1% microorganism inoculant by weight of the final product.

19. A solid fertilizer composition comprising 70.95% humate by weight of the final product, 24.95% monoammonium phosphate by weight of final product, 4% iron oxide ore by weight of the final product, and about 0.1% carbohydrate-containing binding agent by weight of the final product.

20. A solid fertilizer composition comprising 70.9% humate by weight of the final product, 24.9% monoammonium phosphate by weight of final product, 4% iron oxide ore by weight of the final product, about 0.1% carbohydrate-containing binding agent by weight of the final product, and 0.1% microorganism inoculant by weight of the final product.

21. A process for producing a granular fertilizer composition comprising:
a. admixing a humate and a phosphate source while maintaining the temperature of the mixture below 100 degrees C.; and
b. forming granules from said admixture by pressing said admixture together while maintaining the temperature of the admixture below 100 degrees C.

22. The process of claim 21, wherein the temperature is held below 80 degrees C.

23. The process of claim 21, wherein the temperature is held below 65.6 degrees C.

24. A process for producing a granular fertilizer composition comprising:
a. admixing at least 1.5% humic acid by weight of final product and a phosphate source while maintaining the temperature of the mixture below 100 degrees C.; and
b. forming granules from said admixture by pressing said admixture together while maintaining the temperature of the admixture below 100 degrees C.

25. The process of claim 24, wherein the temperature is held below 80 degrees C.

26. The process of claim 24, wherein the temperature is held below 65.6 degrees C.

27. A process for producing a granular fertilizer composition comprising:
a. admixing at least 1.5% humic acid by weight of final product and a phosphate source while maintaining the temperature of the mixture below 100 degrees C. to form an admixture;
b. pressing said admixture together at a pressure between 175.8 and 246.1 kilogram-force per square centimeter while maintaining the temperature of the admixture below 100 degrees C.; and
c. breaking the resultant product of step b into granules.

28. The process of claim 27, further comprising screening said granules of step c to a predetermined size range while maintaining the temperature at less than 80 degrees C.

29. The process of claim 24, 25, 26, 27 or 28, further comprising applying a water repellant coating agent to said granules.

30. A process for producing a granular fertilizer composition comprising:
a. admixing at least 1.5% humic acid by weight of final product and a phosphate source while maintaining the temperature of the mixture below 80 degrees C. to form an admixture;
b. pressing said admixture together at a pressure between 175.8 and 246.1 kilogram-force per square centimeter while maintaining the temperature of the admixture below 80 degrees C.; and
c. breaking the resultant product of step b into granules.

31. The process of claim 30, further comprising screening said granules of step c to a predetermined size range while maintaining the temperature at less than 65.6 degrees C.

32. The process of claim 30 or 31, further comprising applying a water repellant coating agent to said granules.

33. A process for producing a granular fertilizer composition comprising:
a. admixing from 10% to 80% by weight of a phosphate source, from 20% to 80% by weight of a humate, and the balance selected from the group consisting of binders, inoculants, plant nutrient sources, microorganism nutrient sources, iron, phosphate-solubilizing agents, chelating agents, coating agents and combinations thereof to form an admixture while maintaining the temperature below 100 degrees C.; and
b. pressing said admixture together at a pressure between 175.8 and 246.1 kilogram-force per square centimeter while maintaining the temperature of the mixture below 100 degrees C.

34. The process of claim 33, further comprising breaking the resultant product of step b into granules while maintaining the temperature at less than 100 degrees C.

35. The process of claim 33 or 34 wherein the temperature is held below 80 degrees C.

36. The process of claim 33 or 34 wherein the temperature is held below 65.6 degrees C.

37. A product produced by the process of claim 21, 24, 27, 30, or 33.
